(19) United States
(12) Patent Application Publication
(10) Pub. No.: US 2015/0289056 A1
(43) Pub. Date: Oct. 8, 2015

(54) NOISE REDUCTION SYSTEM, A METHOD AND A HELICOPTER

(71) Applicants: Airbus Defence and Space GmbH, Ottobrunn (DE); Airbus Helicopters Deutschland GmbH, Donauwoerth (DE)

(72) Inventors: Stefan Storm, Ottobrunn (DE); Rudolf Maier, Ottobrunn (DE); Rolf Schatz, Donauwoerth (DE)

(21) Appl. No.: 14/680,760

(22) Filed: Apr. 7, 2015

(30) Foreign Application Priority Data
Apr. 8, 2014 (EP) 14163851.0

(51) Int. Cl. H04R 3/00

(52) U.S. Cl. CPC H04R 3/002; H04R 2499/13

(57) ABSTRACT

A noise reduction system for connecting a noise source with a body, having at least one piezoactuator for suppressing a noise transmission from the noise source to the body. The noise reduction system has a first carrying structure to be connected with the noise source and a second carrying structure to be connected with the body. The at least one piezoactuator is positioned in series with the carrying structures and connects them with each other, such that the at least one piezoactuator forms a structural loaded part.

### CROSS-REFERENCES TO RELATED APPLICATIONS

This application claims the benefit of the European patent application No. 14163851.0 filed on Apr. 8, 2014, the entire disclosures of which are incorporated herein by way of reference.

### BACKGROUND OF THE INVENTION

The present invention relates to a noise reduction system for connecting a noise source with a body, a method for suppressing a noise transmission, and a helicopter having such a noise reduction system.

It is known, for example, in connection with the mounting of a helicopter power plant to the helicopter cell by connector struts to suppress structure borne/body noise by an active reduction in the structure borne noise/sound transmission. Such active reduction is accomplished by counteracting or compensating structure borne noise caused by primary loads by counterforces and moments in the form of secondary loads which are controlled in closed loop fashion. Such compensation is, for example, realized by means of magnetostrictive or piezoelectric actuators, in connection with a respective inertia mass, which introduce the required counterforces or moments into the carrier or connector struts.

The actuators are conventionally secured to a first end of the mounting strut or carrier structure and preferably in the longitudinal direction of the strut or carrier structure. An inertia mass is secured to the opposite or second end of the strut or carrier structure. The actuators move the inertia masses secured to the strut or carrier structure in response to the movements of the struts or carrier structure, thereby causing a superposition of two motions or vibrations, namely, the motion of the inertia masses at the foot of the strut or carrier structure is superposed on the motion of the strut or carrier structure in such a way that the two motions cancel each other at least partially, whereby structure borne noise is suppressed. This superposition of motions or vibrations takes place in the frequency range of the structure borne noise. Therefore, the conventional devices are capable of at least partially suppressing the transmission of structure borne noise from the power plant to the helicopter cell.

The relatively large weight of the above described conventional noise damping structure is a disadvantage, especially in aircraft such as helicopter structures. The weight includes the actuators and the inertia masses as well as the spatial integration of the structure into the strut or carrier structure. Another disadvantage of the above conventional construction is seen in that the combination of actuators with inertial masses has been found to be wanting with regard to achieving the intended noise reduction to a desirable extent.

Another known noise reduction system is shown in the U.S. Pat. No. 6,480,609B1. Each noise reduction system has at least one piezoactuator which is integrated into or bonded to a connector strut, for example by a suitable adhesive, whereby the at least one piezoactuator is excited by a control power source. In order to achieve an adequate efficiency, the stability of the connector struts should be minimized. However, minimizing the connector struts stability can cause structural conflicts.

### SUMMARY OF THE INVENTION

An object of the invention is to create a noise reduction system for connecting a noise source with a body that shows a high efficiency and secured a high stability. A further object of the invention is to create an effective method for suppressing a noise transmission, and to create a helicopter having a suppressed structure borne noise transmission from its main power plant to its helicopter cell.

According to the invention, a noise reduction system for connecting a noise source with the body has at least a piezoactuator for suppressing a noise transmission from the noise structure to the body, wherein the noise reduction system has a first carrying structure to be connected with the noise source and a second carrying structure to be connected with the body, wherein the at least one piezoactuator is positioned between the carrying structures and connects the carrying structures with each other.

The noise reduction system is to be positioned with its active moving direction in series in a load path between a main power plant and a cell of a helicopter. In general, the power plant comprises at least a main gear box, assembly parts such as a fan and a main rotor. The at least one piezoactuator acts as a structure part that can be excited by a power supply unit, whereupon noise reduction vibrations can be introduced in the structure noise part. By means of the inventive noise reduction system, three effective degrees of freedom are provided. A first effective degree of freedom is directed in its longitudinal respectively vertical direction. A second effective degree of freedom is a rotation about its transverse axis. A third effective degree of freedom is a rotation about an axis that is orthogonal to the longitudinal axis and the transversal axis. The noise reduction causes a blocking of a structure borne noise transmission in the longitudinal direction of the connector struts as well as in the transversal direction. Further on, the noise reduction system can be used for retrofitting. If an adequate quantity of piezoactuators is provided, the main power plant and the helicopter cell are only connected to each other by the piezoactuators. Herewith, a high efficiency and a high stability can be reached. As the inventive noise reduction system can be installed at the helicopter cell, requirements for certification reasons regarding electrical current do not appear. In particular, as the piezoactuators are fixed to the helicopter cell, the wiring of the noise reduction system is simplified.

In order to avoid a destruction of the at least one piezoactuator due to inadequate elongation, at least one pretension element for preventing an elongation of the at least one piezoactuator is positioned in series with the at least one piezoactuator. Preferably, the at least one piezoactuator is such positioned between the aforementioned exemplary main power plant and the helicopter cell that in flight it is pressure loaded, i.e., shortened. Thus, in principal, an inadequate elongation could only appear on the ground. However, in order to avoid such an elongation on the ground, the at least one pretension element is provided, generating a pressure force in counterdirection to the elongation. In one embodiment, the at least one pretension element is a spring such as a plate spring that can be pretensioned by the weight of the helicopter cell.

In another embodiment, the pretension element is a so called antagonist-piezoactuator acting in a counterdirection to the primary piezoactuator. Such a noise reduction system enables an orientation in a direction in which the pretention cannot be generated by weight. For instance, by means of at least an antagonist-piezoactuator as a pretension element, the noise reduction system can be positioned horizontally, i.e., in an orientation in which the active moving direction of the at least one primary piezoactuator is in a horizontal direction and thus in a direction in which no weight, for instance of a helicopter cell, acts.

In order to avoid a separation of the carrying structures in the unlikely event that the at least piezoactuator is destroyed, for example due to an inadequate elongation or shortening, a fallback-system for limiting a maximum positive or negative alternation of length of the at least one piezoactuator is provided. Hereby, the carrying structures abut mechanically against each other if a maximum positive or negative alternation of length appears.

Additionally, to the at least one piezoactuator, the second carrying structure can has at least one vibration insulation element being in series with the at least one piezoactuator. By means of this, a more effective noise reduction can be achieved. Preferably, the at least one vibration insulation element is a passive element, in particular a low frequency passive vibration insulation element. One example for a passive vibration insulation element is the so-called Antiresonance-Rotor-Insulation-System (ARIS). Thereby, the at least piezoactuator can be integrated in ARIS. Thus, the design size can be reduced.

Further on, heat generated by the at least one piezoactuator can be used for further applications. Thus, the at least one piezoactuator is a heat source for further applications. For instance, the heat generated by the at least one piezoactuator can be used for warming up hydraulic fluid of ARIS. By means of this, a weight reduction can be achieved as less hydraulic fluid is necessary.

Preferably, the second carrying structure has a stop element positioned between an attachment point for purposes of connection the second carrying structure to the noise source and the at least one vibration insulation element. The stop element creates a mechanical stop with a counter element of the first carrying structure for limiting a maximum positive or negative alternation of length of the at least one piezoactuator and/or of the at least one vibration element. Hereby, a further fallback-system is created, considering in particular the installation of the at least one vibration insulation element.

In a preferred embodiment, the at least one piezoactuator is an annular body that is connected with its front ends to the carrying structures, wherein a tie rod is led through the at least one piezoactuator. The tie rod is connected with one end to the first carrying structure and is led with its free section through the second carrying structure, wherein the at least one pretension element is positioned between a free end of the tie rod and the second carrying structure. Thus an arrangement is advantageous for detecting the structure noise and transferring noise reduction vibrations in the noise transmission path between the noise source and the body.

In order to react directly on the structure noise, the noise reduction system comprises at least a control circuit, having a detector for detecting at least one physical value and which is aligned to the at least one piezoactuator, an evaluation unit for evaluating the physical value and an activation unit for activating the at least one piezoactuator in dependence on the detected physical value. Thereby, it is preferred, that the physical value is acceleration. An acceleration detector enables an ease detection of longitudinal and bending directions via matrix calculations. Preferably the detector is such aligned to the at least on piezoactuator that they are positioned on one vertical axis. The activation unit comprises a control element having preferably an integrated amplifier, for instance. Preferably, the detector is attached to the free end of the tie rod, so that the structure noise can be detected on very a short way.

Preferably, at least one second detector is provided for detecting a second physical value which is different to the first physical value. In a preferred embodiment of the control circuit, the second physical value is a detector for detecting a rotation speed, for instance the rotation speed of the main rotor or of a drive shaft of the main gear box, which is then considered for evaluation. Further on, the control circuit can comprise at least one filter element for extracting interference signals. The interfering signals are then eliminated by actuating the piezoactuators for generating countersignals later.

In one preferred embodiment, the noise reduction system comprises a plurality of parallel piezoactuators. Thus, holding forces acting on each piezoactuator due to their structural integration in the load path is reduced. This is advantageous for generating and introducing the noise suppressing vibrations. In this case it is preferred, if the piezoactuators of one noise reduction system are acting as a single unit and are activated simultaneously. It is preferred, when the noise reduction system comprises only one vibration insulation element. The application of only one vibration insulation element additional to the piezoactuators simplifies the noise reduction process over all.

According to the invention, in a method for suppressing a noise transmission generated by a noise source to a body to which the noise source is attached, interfering signals of a structure borne noise are determined and suppressed by countersignals produced by at least one piezoactuator acting as a structural part and being positioned with its active moving direction in series with the noise source and the body. Such a method enables a very effective structure borne noise reduction, as the at least one piezoactuator is integrated in the load path.

According to the invention, a helicopter has a main power plant that is connected with its cell by a plurality of noise reduction systems according to the invention. Hereby, a transmission of a structure borne noise generated by the power plant and thus a transformation of the structure borne noise in a cabin as airborne noise is suppressed. Preferably, one noise reduction system is integrated in each connector strut extending between the main power plant and the helicopter cell. Additionally, one noise reduction system can be integrated in a connector strut extending horizontally. In general, the power plant comprises at least a main gear box, assembly parts such as a fan and a main rotor.

It is preferred that each noise reduction system can be activated individually independent on an activation of the other noise reduction systems. By means of this, each noise transmission path is watched individually.

### BRIEF DESCRIPTION OF THE DRAWINGS

In what follows preferred examples of the embodiment of the invention are illustrated in more detail with the aid of highly simplified schematic representations. Here:

FIG. 1 shows a front view of a helicopter showing a main power plant being connected to a helicopter cell by vertical connector struts,

FIG. 2 shows a schematic integration of a first embodiment of an inventive noise reduction system in the vertical connector struts,

FIG. 3 shows the principle construction of the noise reduction system,

FIG. 4 shows a cross-section of the noise reduction system shown in FIG. 3, and

FIG. 5 shows a second embodiment of an inventive noise reduction system according to the invention.

### DETAILED DESCRIPTION OF THE PREFERRED EMBODIMENTS

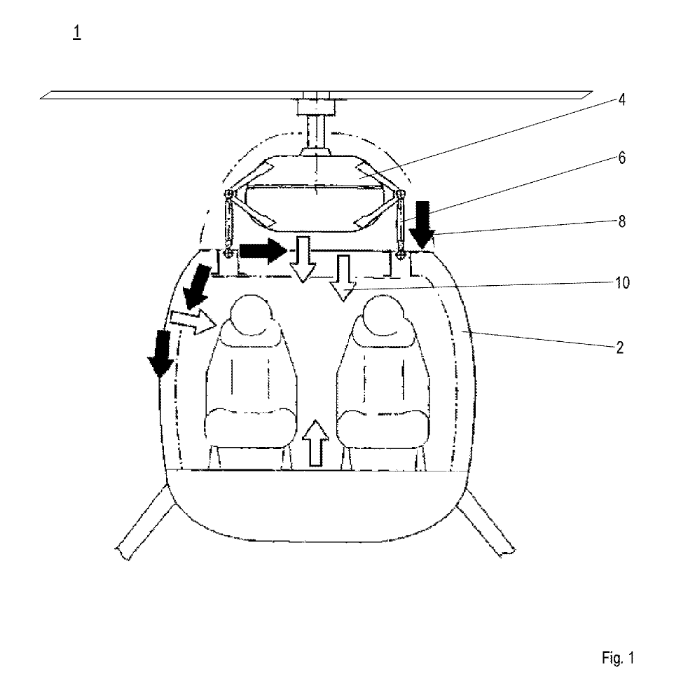

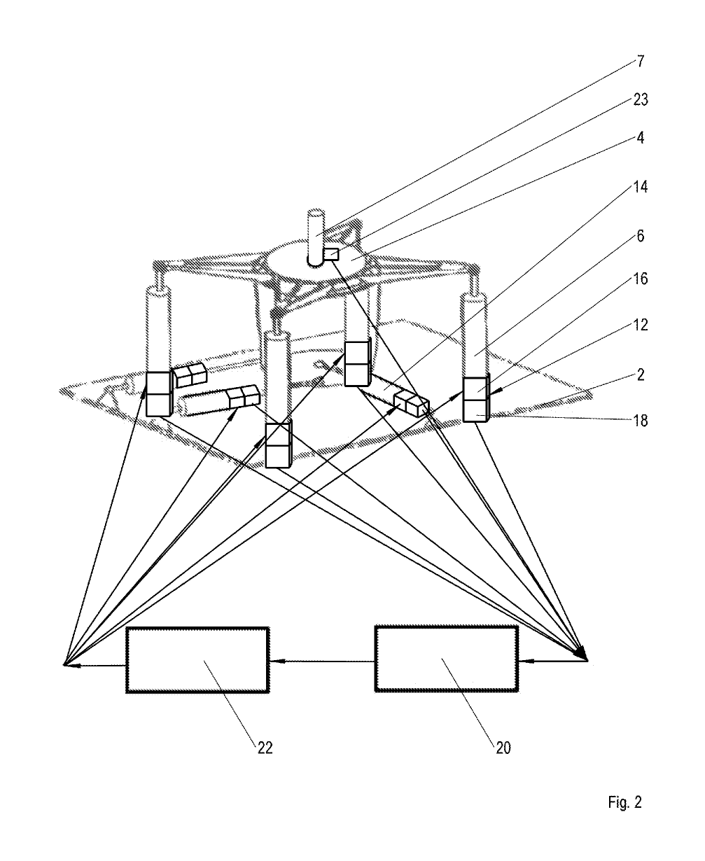

In FIG. 1, a helicopter 1 according to the invention is shown. The helicopter 1 has a fuselage or a cell 2 defining a cabin and a power plant 4. The power plant 4, a noise source respectively a vibration source, is connected to the cell 2, respectively a body, by a plurality of vertical connector struts 6. In general, the power plant 4 comprises at least a main gear box, assembly parts such as a fan and a main rotor 7, which for the sake of simplicity is here illustrated as a rotor shaft. Thus, in the shown embodiment the connector struts 6 are main gear box struts. In order to avoid a transmission of a structure noise 8 generated by the power plant 4, and thus in order to avoid a transformation of the structure noise 8 in airborne noise 10 in the cabin, as shown in FIG. 2, in each vertical connector 6 a first embodiment of an inventive noise reduction system 12 is integrated. Thus, the power plant 4 is connected structurally to the helicopter cell 2 by a plurality of noise reduction systems 12. Additionally, a second embodiment of the noise reduction system 12 can be integrated in horizontal connector struts 14. The second embodiment is shown in FIG. 5.

According to FIG. 2, the first embodiment of the noise reduction system 12 comprises at least one piezoactuator 16 which is positioned in series between the power plant 4 and the cell 2 by integration in the vertical connector struts 6. The noise reduction systems 12 are connected with a control circuit comprising a detector 18 or sensor, respectively, for measuring a physical value such as acceleration, an evaluation unit 20 for evaluating the measured/detected value or signals, respectively, and an activation unit 22 for activating the piezoactuators 16 in dependence on the detected physical value in order to suppress the transmission and the transfer of structure noise 8 in the airborne noise 10. Therefore, the activation unit 22 comprises a control element. Additionally, an amplifier is integrated into the activation unit 22 for amplifying the activation signal of the control element to the piezoactuators 16. Preferably, the control element is a micro controller and the amplifier operates in a pulsed mode. A quantity of the detectors 18 depends on the quantity of piezoactuators 16. As shown in the following figures, in this embodiment the same quantities of detectors 18 and piezoactuators 48, 50, 52 are provided.

Additionally, a detector 23 for detecting a second physical value different from the first physical value is provided. Here, the second detector 23 is a detector for detecting a rotation speed of the rotor 7. Further on, in the shown embodiment it is preferred, if the detected acceleration is filtered in such a way that interfering signals such as interfering vibrations are extracted from the measured signals first, wherein the interfering signals are then eliminated by actuating the piezoactuators 16 for generating countersignals. Hereby, each piezoactuator 16 can be actuated individually. Additionally, an amplifier, not separately illustrated, can be provided for amplifying the activation signal of the piezoactuators 16. Preferably, in the amplifier is integrated into the at least one piezoactuator 16

If, as mentioned in FIG. 1, a plurality of noise reduction systems 12 is provided, each single noise reduction system 12 can be actuated individually. If, as shown in the following figures, a noise reduction system 12 comprises more than one piezoactuators 48, 50, 52, the piezoactuators 48, 50, 52 of one noise reduction system 12 form a joint piezoactuator unit and are actuated simultaneously.

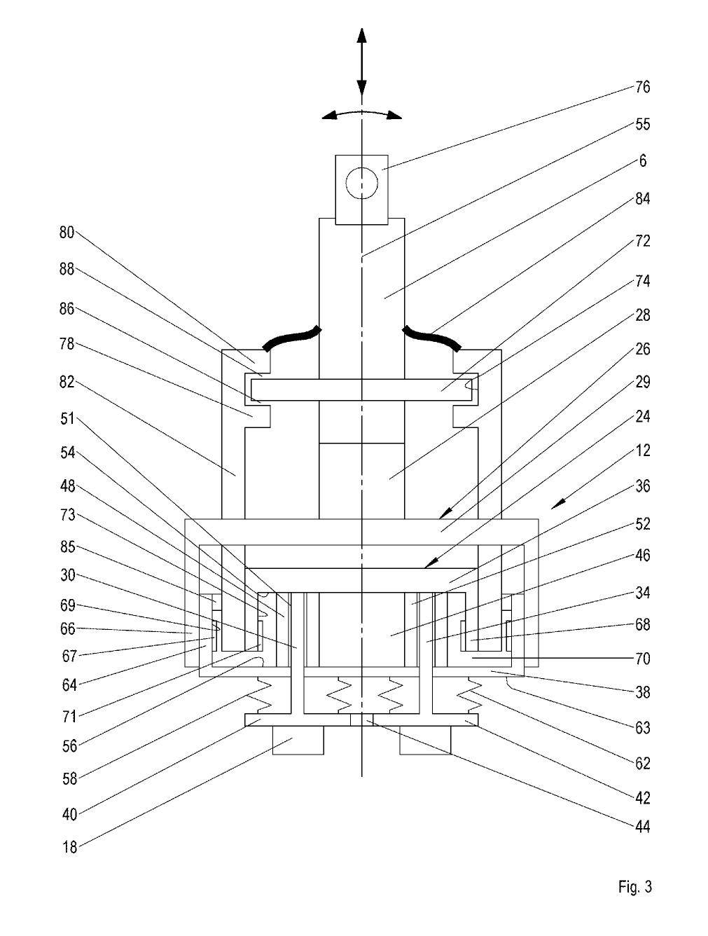

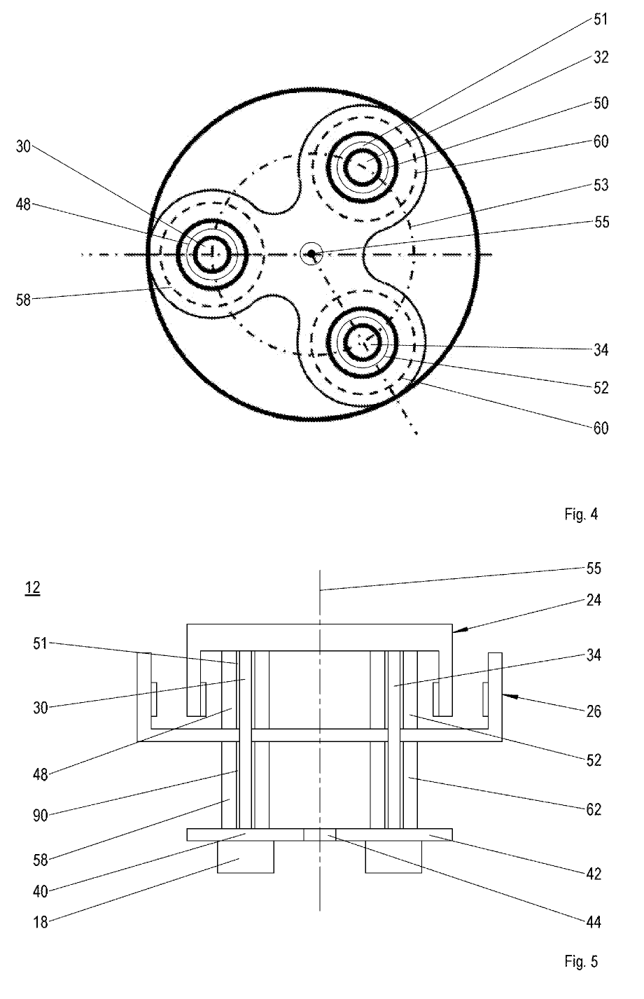

In FIGS. 3 and 4, the first embodiment of the noise reduction system 12 is illustrated in more detail. The noise reduction system 12 has a first carrying structure 24 and a second carrying structure 26. The first carrying structure 24 is fixed to the cell 2 and the second carrying structure 26 is fixed to each vertical connector strut 6 and thus to the power plant 4, respectively, the noise source. Further on, the noise reduction system 12 has one vibration insulation element 28.

The vibration insulation element 28 is, for example, a passive element and in particular a passive low frequency element such as the known so-called ARIS (Antiresonance-Rotor-Insulation-System). It is positioned between the connector strut 6 and an upper part 29 of the second carrying structure 26 and forms a structural connection between them.

The noise reduction system 12 has in this embodiment three parallel tie rods 30, 32, 34 which are attached with their one front end to an upper part 36 of the first carrying structure 24 and which are led through a lower part 38 of the second carrying structure 26 with their free sections. Each tie rod 30, 32, 34 has a broadened free end 40, 42, the free ends being optionally connected to each other by an anti-rotary device 44.

In a space 46 between the upper part 36 of the first carrying structure 24 and the lower part 38 of the second carrying structure 26, three piezoactuators 48, 50, 52 are positioned. In the shown embodiment, the three parallel piezoactuators 48, 50, 52 are provided. The piezoactuators 48, 50, 52 are annular bodies that encompass the tie rods 30, 32, 34 and which are connected with their front ends to an inner surface 54 of the upper part 36 and to an opposite inner surface 56 of the lower part 38. Thereby, the piezoactuators 48, 50, 42 are radially spaced apart with their inner circumferential surfaces from opposite outer circumferential surfaces of the tie rods 30, 32, 34, thus forming an annular space 51. The annular space 51 is filled up with an electrical isolating material having a high heat conductivity. By using a material which has a high heat conductivity, a heat transfer from the piezoactuators 48, 50, 52 to the tie rods 30, 32, 34 is improved in radial direction. In axial direction, the heat is transferred from the piezoactuators 48, 50, 52 to the lower part 38 of the second structure 26 and to the upper part 36 of the first structure 24 by their front ends.

As shown in FIG. 4, the tie rods 30, 32, 34 and thus the piezoactuators 48, 50, 52 are positioned regularly on a virtual circle 53 that is concentric to a vertical axis 55 of the connector strut 6 and thus to the vibration insulation element 28 whose longitudinal axis is in line with the vertical axis 55. As the piezoactuators 48, 50, 52 are positioned concentrically to the vertical axis 55 of the connector strut 6, the vertical axis 55 represents additionally the active moving direction of the piezoactuators 48, 50, 52.

In order to avoid an elongation of the piezoactuators 48, 50, 52 on ground, a pretension element 58, 60, 62 is allocated to each piezoactuator 48, 50, 52. The pretension elements 58, 60, 62 are, in the shown embodiment, plate springs that are positioned between an outer surface 63 of the lower part 38 of the second carrying structure 26 and the broadened end sections 40, 42 of the tie rods 30, 32, 34. At a lower surface of the broadened end sections 40, 42 the detector 18 is positioned. Thus, each detector 18 is in line with one of the tie rods 30, 32, 34 and is additionally positioned on the virtual circle 53.

The lower part 38 of the second carrying structure 26 and the upper part 29 of the second carrying structure 26 are connected by vertical sections 64, 66. At least two sections 64 extend in an upward direction from the lower part 38 and at least two sections 66 extend in a downward direction from the upper part 29. In the illustrated embodiment, the vertical sections 64 are a kind of flange used for attaching the noise reduction system 12 to the power plant 4. Therefore, here the lower part 29 and its vertical sections 64 are U-shaped. Preferably, the connection to the power plant 4 is done by threaded systems, wherein nuts 67 are fixed to an inner surface 69 of the sections 64 for receiving screws or threaded bolts. In order to prevent an unintentional loosening of the threaded systems, adequate anti-rotating means are provided.

In order to create a fallback-system in the unlikely event that the piezoactuators 48, 50, 52 are damaged, a mechanical stop is provided between the lower part 38 of the second element 26 and the upper part 28 first carrying structure 24. For this, the upper part 36 of the first carrying structure 24 has at least two vertical sections 68 extending in downward direction to the lower part 38 of the second carrying structure 26. The section 68 has such a length that in a normal state a gap 70 is provided with the inner surface 56 of the lower part 38 of the carrying structure 26. If in the unlikely event of a breakdown of the piezoactuators, in flight the cylindrical wall 68 abuts against the inner surface 56 of the lower part 38 of the second carrying structure 26. In the illustrated embodiment, the vertical sections 68 are a kind of flange used for attaching the noise reduction system 12 to the helicopter cell 2. Therefore, here the upper part 36 and its vertical sections 68 are U-shaped. Preferably, the connection to the helicopter cell 2 is done by threaded systems, wherein nuts 71 are fixed to an inner surface 73 of the sections 68 for receiving screws or threaded bolts. In order to prevent an unintentional loosening of the threaded systems, adequate anti-rotating means are provided.

The orientation of the upper vertical sections 64 of the second carrying structure 26 and the lower vertical sections 68 of the first carrying structure 24 are here in such a way relative to each other that they are inclined in an angle of 90° related to the longitudinal axis 55. By means of this, the attaching of the noise reduction system 12 to the helicopter cell 2 and the power plant 4 is facilitated, as the vertical sections 64, 68 or flanges do not block the access to each other.

If, as exemplarily shown, the vibration insulation element 28 is integrated in the noise reduction system 12 and positioned between the connector strut 6 and the upper part 29 of the second carrying structure 26, a further fallback-system is provided. This fallback-system is a mechanical stop and used for both limiting a maximum positive or negative alternation of length of the piezoactuators 48, 50, 52 and limiting a maximum positive or negative alternation of length of the at least one vibration insulation element 28. The fallback-system comprises a stop element 72 allocated to the connector strut 6 and a counter element 74 allocated to the first carrying structure 24.

In the shown embodiment, the stop element 72 is an annular shoulder extending radially from the connector strut 6 between an attachment point 76 for purposes of attaching the noise reduction system 12 to the power plant 4. The counter element 74 is a groove having a lower groove wall 78 and an upper groove wall 80 between which the stop element 72 is positioned. The groove, respectively its horizontal walls 78, 80, are provided on an inner side of a vertical holding element 82. The vertical holding element 82 is led through the upper part 29 of the second carrying structure 26 and has a foot section which is attached to the lower wall 68 of the upper part 38 of the first carrying structure 24 and a head section forming the counter element, respectively the groove 74. Preferably the holding element 82 has a cylindrical shape and is in threaded connection with the wall 68 of the first carrying structure 24 and thereby secured against rotation. Due to the preferred cylindrical shape, at least a lateral housing is created protecting the vibration insulation element 28 against pollution. In order to close the housing in the vertical direction, a seal 84 is provided extending from the counter strut 6 to the upper groove wall 90. In order to prevent pollution from entering the space 46 in which the piezoactuators 48, 50, 52 are positioned, a seal is provided in a clearance 85 between the upper section 56 of the lower part 38 of the second carrying structure 26 and the feed section of the holding element 82.

In the normal state, the stop element 72 is spaced apart from the lower groove wall 78 and from the upper groove wall 80 such that a lower gap 86 and an upper gap 88 are provided. Preferably, the gaps 86, 88 have a greater extension in the vertical direction than the gap 70 between the wall 68 of the first carrying section 24 and the lower part 38 of the second carrying section 26. Thus the mechanical stop created by the stop element 72 and the counter element 74 acts firstly, wherein the mechanical stop created by the wall 68 and the lower part 38 acts secondly.

As shown in FIG. 5, in difference to the first embodiment discussed above, three pretension elements 58, 60, 62 are piezoactuators as well. Due to the perspective used in FIG. 5, only two pretension elements 58, 60 and two original piezoactuators 48, 52 are shown. The pretension elements 58, 60, 62 are acting as or are antagonist-piezoactuators, such that an elongation of the piezoactuators 48, 50, 52 on the ground is prevented. As mentioned before, preferably, the embodiment shown in FIG. 5 is used for integration into the horizontal connector struts 14. The antagonist-piezoactuators 58, 60, 62 are also radially spaced apart with their inner circumferential surfaces from opposite outer circumferential surfaces of the tie rods 30, 32, 34, thus forming an annular space 90. The annular space 90 is also filled up with an electrical isolating material having a high heat conductivity. In the axial direction, the heat is also transferred from the piezoactuators 58, 60, 62 to the lower part 38 of the second structure 26 and to the end sections 40, 42 of the tie rods 30, 32, 34 by their front ends. Other references used in FIG. 5 refer to the same constructive elements as shown in FIG. 3.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

1 helicopter
2 fuselage/cell/body
4 power plant/noise source
6 vertical connector strut
7 main rotor
8 structure borne noise/structure borne sound/body noise
10 airborne noise
12 noise reduction system
14 horizontal connector strut
16 piezoactuator
18 detector/sensor
20 evaluation unit
22 activation unit
23 detector/sensor
24 first carrying structure
26 second carrying structure
28 vibration insulation element
29 upper part
30 tie rod
32 tie rod
34 tie rod
36 upper part
38 lower part
40 end section
42 end section
44 anti-rotary device
46 space
48 piezoactuator
50 piezoactuator
52 piezoactuator
51 annular space
53 virtual circle
54 inner surface
55 vertical axis
56 inner surface
58 pretension element/plate spring/antagonist-piezoactuator
60 pretension element/plate spring/antagonist-piezoactuator
62 pretension element/plate spring/antagonist-piezoactuator
63 outer surface
64 section of lower part
66 section of upper part
67 nut
68 section of upper part
69 inner surface
70 gap
71 nut
72 stop element
73 inner surface
46 counter element
76 attachment point
78 lower wall
80 upper wall
82 holding element
84 seal
85 seal
86 lower gap
88 upper gap
90 annular space

1. A noise reduction system for connecting a noise source with a body, comprising:
at least one piezoactuator for suppressing a noise transmission from the noise source to the body,
a first carrying structure to be connected with the body source, and
a second carrying structure to be connected with the noise source,
wherein the at least one piezoactuator is positioned between the carrying structures and connects the carrying structures with each other.

2. The noise reduction system according to claim 1, wherein at least one pretension element for preventing an elongation of the at least piezoactuator is positioned in series with the at least one piezoactuator.

3. The noise reduction system according to claim 2, wherein the at least one pretension element is an antagonist-piezoactuator.

4. The noise reduction system according to claim 1, wherein the carrying structures create a mechanical stop for limiting a maximum positive or negative alternation of length of the at least one piezoactuator.

5. The noise reduction system according to claim 1, wherein the second carrying structure has at least one vibration insulation element being in series with the at least one piezoactuator.

6. The noise reduction system according to claim 1, wherein the at least one piezoactuator is a heat source for further applications.

7. The noise reduction system according to claim 5, wherein the second carrying structure has a stop element positioned between an attachment point for purposes of connection the second carrying structure to the noise source and the at least one vibration insulation element creating a mechanical stop with a counter element of the first carrying structure for limiting a maximum positive or negative alternation of a length of at least one of the at least one piezoactuator and the at least one vibration insulation element.

8. The noise reduction system according to claim 2, wherein the at least one piezoactuator is a annular body that is connected with its front ends to the carrying structures, wherein a tie rod is led through the piezoactuator, wherein the tie rod is connected with one end to the first carrying structure and is led with its free section through the second carrying structure, wherein the at least one pretension element is positioned between a free end of the tie rod and the second carrying structure.

9. The noise reduction system according to claim 1, wherein the noise reduction system comprises at least a control circuit, having
a detector for detecting at least one physical value and which is aligned to the at least one piezoactuator,
an evaluation unit for evaluating the physical value, and
an activation unit for activating the at least one piezoactuator in dependence on the detected physical value.

10. The noise reduction system according claim 9, wherein a second detector is provided for detecting a second physical value which is different from the first physical value.

11. The noise reduction system according to claim 1, wherein the noise reduction system comprises a plurality of parallel piezoactuators.

12. The noise reduction system according claim 11, wherein each piezoactuator is individually controllable.

13. A method for suppressing a noise transmission generated by a noise source to a body to which the noise source is attached, comprising the steps:
determining interfering signals of a structure borne noise,
suppressing the determined interfering signals by countersignals generated by at least one piezoactuator acting as a structural part and being positioned with its active moving direction in series with the noise source and the body.

14. A helicopter, comprising:
a power plant,
a helicopter fuselage connected to the power plant by a plurality of noise reduction systems, each noise reduction system, comprising:
at least one piezoactuator for suppressing a noise transmission from the noise source to the body,
a first carrying structure to be connected with the body source, and
a second carrying structure to be connected with the noise source,
wherein the at least one piezoactuator is positioned between the carrying structures and connects the carrying structures with each other.

15. The helicopter to claim 14, wherein the noise reduction systems are individually actuatable.
